(19) United States
(12) Patent Application Publication
(10) Pub. No.: US 2019/0274076 A1
(43) Pub. Date: Sep. 5, 2019

(54) METHOD FOR SUPPORTING UE MOBILITY IN WIRELESS COMMUNICATION SYSTEM AND DEVICE THEREFOR

(71) Applicant: LG ELECTRONICS INC., Seoul (KR)

(72) Inventors: Dongsoo KIM, Seoul (KR); Jinsook RYU, Seoul (KR); Myungjune YOUN, Seoul (KR); Taehun KIM, Seoul (KR); Hyunsook KIM, Seoul (KR)

(21) Appl. No.: 16/344,736

(22) PCT Filed: Feb. 27, 2017
(86) PCT No.: PCT/KR2017/002170

§ 371 Date: Apr. 24, 2019

Related U.S. Application Data
(60) Provisional application No. 62/412,802, filed on Oct. 25, 2016.
(60) Provisional application No. 62/418,269, filed on Nov. 6, 2016.

(51) Int. Cl. H04W 36/00; H04W 48/10

(52) U.S. Cl. CPC H04W 36/0058; H04W 36/00837; H04W 48/10; H04W 36/00835

(57) ABSTRACT

Provided are a method for supporting UE mobility in a wireless communication system and a device therefor. Specifically, the method for supporting mobility of a user equipment (UE) by a source access node in a wireless communication system, includes transmitting, to the UE, a measurement configuration instructing to include capability information regarding tunneling models of neighbor access nodes in a measurement report receiving, from the UE, the measurement report including capability information regarding the tunneling models of the neighbor access nodes and determining a target access node to which the UE is to perform handover on the basis of the measurement report.

### CROSS-REFERENCE TO RELATED APPLICATION

This application is the National Stage filing under 35 U.S.C. 371 of International Application No. PCT/KR2017/002170, filed on Feb. 27, 2017, which claims the benefit of U.S. Provisional Application No. 62/412,802, filed on Oct. 25, 2016, No. 62/418,269, filed on Nov. 6, 2016, the contents of which are all hereby incorporated by reference herein in their entirety.

### BACKGROUND OF THE INVENTION

### Field of the Invention

The present invention relates to a wireless communication system and, more particularly, to a method for supporting mobility of a user equipment (UE) and a device therefor.

### Related Art

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### SUMMARY OF THE INVENTION

The present invention provides a method for supporting mobility (e.g., handover, etc.) of a user equipment (UE) in a wireless communication system.

The present invention also provides a method for supporting mobility of a UE in consideration of a tunneling model that a UE is currently using when each access node has a different capability for a tunneling model.

Technical subjects of the present invention that may be obtained in the present invention are not limited to the foregoing technical subjects and any other technical subjects not mentioned herein may be easily understood by a person skilled in the art from the present disclosure and accompanying drawings.

In an aspect, a method for supporting mobility of a user equipment (UE) by a source access node in a wireless communication system, includes: transmitting, to the UE, a measurement configuration instructing to include capability information regarding tunneling models of neighbor access nodes in a measurement report; receiving, from the UE, the measurement report including capability information regarding the tunneling models of the neighbor access nodes; and determining a target access node to which the UE is to perform handover on the basis of the measurement report.

In another aspect, a source access node for supporting mobility of a user equipment (UE) in a wireless communication system, includes: a communication module transmitting and receiving signals; and a processor controlling the communication module, wherein the processor transmits, to the UE, a measurement configuration instructing to include capability information regarding tunneling models of neighbor access nodes in a measurement report; receives, from the UE, the measurement report including capability information regarding the tunneling models of the neighbor access nodes; and determines a target access node to which the UE is to perform handover on the basis of the measurement report.

Preferably, the capability information regarding tunneling models of neighbor access nodes may include a list of neighbor access nodes for supporting a tunneling model which may be supported by each of the neighbor access nodes, a tunnel currently supported by each of the neighbor access nodes and/or a tunneling model in use by the UE.

Preferably, the list of neighbor access nodes for supporting the tunneling model in use by the UE may include only a neighbor access node which may support the tunneling model in use by the UE, include both the neighbor access node which may support the tunneling model in use by the UE and a neighbor access node which cannot support the tunneling model in use by the UE, wherein whether each of the neighbor access nodes may support the tunneling model is indicated, or include both the neighbor access node which may support the tunneling model in use by the UE and the neighbor access node which cannot support the tunneling model in use by the UE, wherein the neighbor access node which may support the tunneling model in use by the UE is given a high priority.

Preferably, information regarding the tunneling model which may be supported by the neighbor access node and/or information regarding the tunnel currently supported by the neighbor access node may be broadcast in a system information block from the neighbor access nodes, respectively.

Preferably, an access node having highest signal strength, among access nodes which may support the tunneling model of the UE, may be determined as the target access node on the basis of the capability information regarding the tunneling models of the neighbor access nodes.

Preferably, when a plurality of sessions using different tunneling models for the UE are established, an access node having highest signal strength, among access nodes which may support all of the tunneling models for the UE, may be determined as the target access node on the basis of the capability information regarding the tunneling models of the neighbor access nodes.

Preferably, when a plurality of sessions using different tunneling models for the UE are established, an access node having highest signal strength, among access nodes which may support tunneling models with high priority among the tunneling models for the UE, may be determined as the target access node on the basis of the capability information regarding the tunneling models of the neighbor access nodes.

Preferably, information regarding the priority may be received from a node of a core network or the priority is previously set in the source access node.

Preferably, the tunneling models may include a tunneling model for each QoS class, a tunneling model for each packet data unit (PDU) session, and/or a tunneling model for each node level.

According to an embodiment of the present invention, mobility of the UE between access nodes which are able to support different tunneling models may be efficiently supported.

Also, according to an embodiment of the present invention, since mobility of the UE to an access node which is able to support a tunneling model being used by the UE is induced, signaling overhead, such as newly establishing a tunnel according to the tunneling model being used by the UE, may be reduced.

It will be appreciated by persons skilled in the art that the effects that may be achieved with the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention may be applied.

FIG. 2 illustrates an example of evolved universal terrestrial radio access network structure to which the present invention may be applied.

FIG. 3 exemplifies a structure of E-UTRAN and EPC in a wireless communication system to which the present invention may be applied.

FIG. 4 illustrates a structure of a radio interface protocol between a UE and E-UTRAN in a wireless communication system to which the present invention may be applied.

FIG. 5 is a diagram schematically showing a structure of a physical channel in a wireless communication system to which the present invention may be applied.

FIG. 6 is a diagram for describing a contention based random access procedure in a wireless communication system to which the present invention may be applied.

FIG. 7 illustrates an X2-based handover procedure without S-GW relocation in a wireless communication system to which the present invention may be applied.

FIG. 8 illustrates an X2-based handover procedure involving S-GW relocation in a wireless communication system to which the present invention may be applied.

FIG. 9 illustrates a handover (i.e., intra-MME/S-GW HO) scenario in which an MME and an S-GW are not changed in a wireless communication system to which the present invention may be applied.

FIG. 10 is a diagram illustrating a session management function in a wireless communication system to which the present invention is applied.

FIG. 11 illustrates a tunnel protocol for each QoS class in a wireless communication system to which the present invention may be applied.

FIG. 12 illustrates a tunnel protocol for each node level in a wireless communication system to which the present invention may be applied.

FIG. 13 illustrates a tunnel protocol for each node level for generating one tunnel for each destination in a wireless communication system to which the present invention may be applied.

FIG. 14 illustrates a scenario for a fixed wireless terminal and a mobile terminal in a wireless communication system to which the present invention may be applied.

FIG. 15 illustrates an attachment of a UE to a network by an access node (AN)-level tunnel in a wireless communication system to which the present invention may be applied.

FIG. 16 is a diagram illustrating a method of supporting mobility of a UE according to an embodiment of the present invention.

FIG. 17 is a block diagram of a communication device according to an embodiment of the present invention.

FIG. 18 is a block diagram of a communication device according to an embodiment of the present invention.

### DESCRIPTION OF EXEMPLARY EMBODIMENTS

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the U MTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Public Land Mobile Network (PLMN): a network formed to provide mobile communication services to individuals. The PLMN may be formed separately for each operator.
Non-Access Stratum (NAS): a functional layer for exchanging signals and traffic messages between a terminal and a core network at the UMTS and EPS protocol stack. The NAS is used primarily for supporting mobility of a terminal and a session management procedure for establishing and maintaining an IP connection between the terminal and a PDN GW.

In what follows, the present invention will be described based on the terms defined above.

Overview of System to which the Present Invention May be Applied

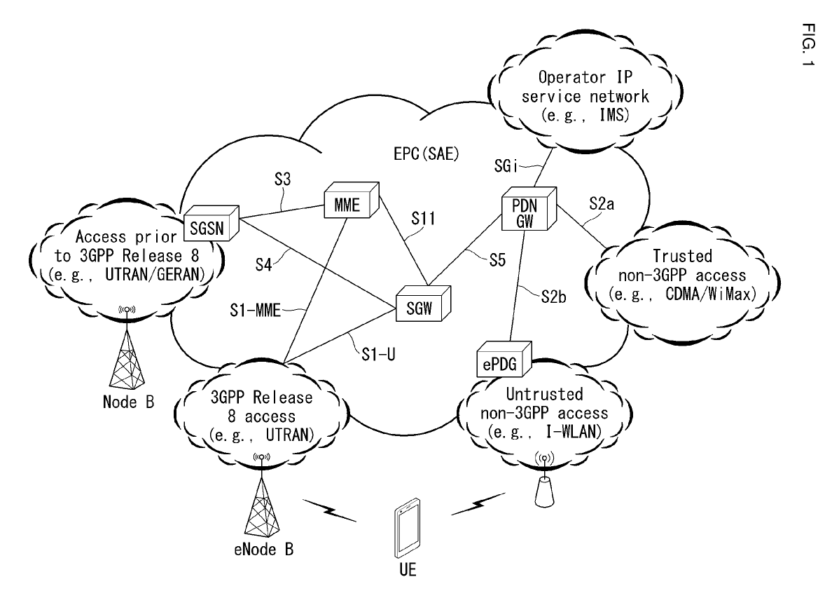

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (e.g., eNodeB), EPC, and application domain (e.g., IMS). In other words, the EPC provides the architecture essential for implementing end-to-end IP services.

The EPC comprises various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, in case the UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (e.g., an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (e.g., the GPRS network).

The ePDG acts as a security node with respect to an unreliable, non-3GPP network (e.g., I-WLAN, WiFi hotspot, and so on).

As described with respect to FIG. 1, a UE with the IP capability may access the IP service network (e.g., the IMS) that a service provider (namely, an operator) provides, via various components within the EPC based not only on the 3GPP access but also on the non-3GPP access.

Also, FIG. 1 illustrates various reference points (e.g., S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| Reference | |
|---|---|
| point | Description |
| S1-MME | Reference point for the control plane protocol between E- |
| | UTRAN and MME |
| S1-U | Reference point between E-UTRAN and Serving GW for the |
| | per bearer user plane tunneling and inter eNodeB path |
| | switching during handover |
| S3 | It enables user and bearer information exchange for inter |
| | 3GPP access network mobility in idle and/or active state. This |
| | reference point may be used intra-PLMN or inter-PLMN (e.g. |
| | In the case of Inter-PLMN HO). |
| S4 | It provides related control and mobility support between |
| | GPRS core and the 3GPP anchor function of Serving GW. In |
| | addition, if direct tunnel is not established, it provides the user |
| | plane tunneling. |
| S5 | It provides user plane tunneling and tunnel management |
| | between Serving GW and PDN GW. It is used for Serving |
| | GW relocation due to UE mobility if the Serving GW needs |
| | to connect to a non-collocated PDN GW for the required |
| | PDN connectivity. |
| S11 | Reference point for the control plane protocol between MME |
| | and SGW |
| SGi | It is the reference point between the PDN GW and the packet |
| | data network. Packet data network may be an operator |
| | external public or private packet data network or an intra- |
| | operator packet data network (e.g., for provision of IMS |
| | services). This reference point corresponds to Gi for 3GPP |
| | accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

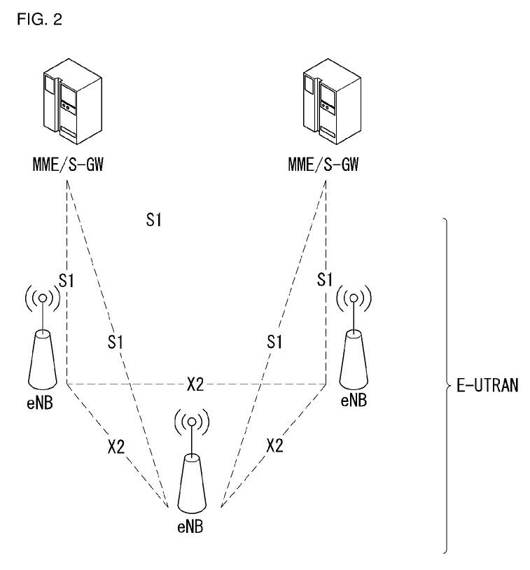

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

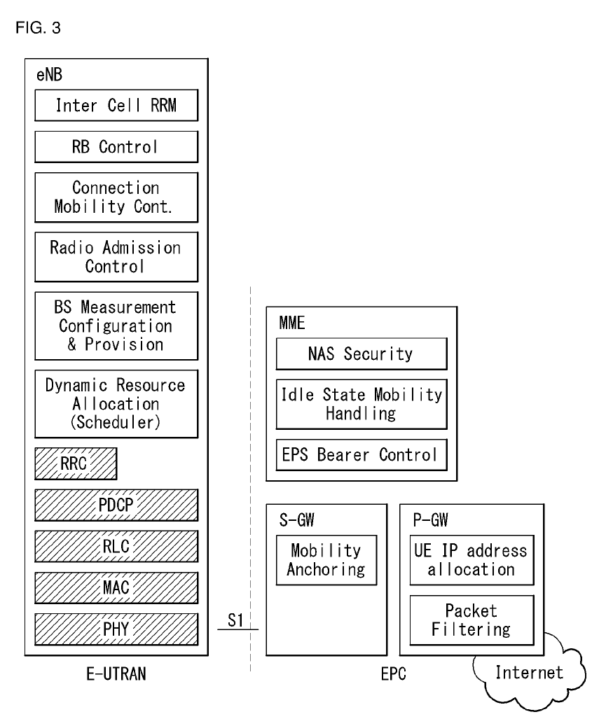

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

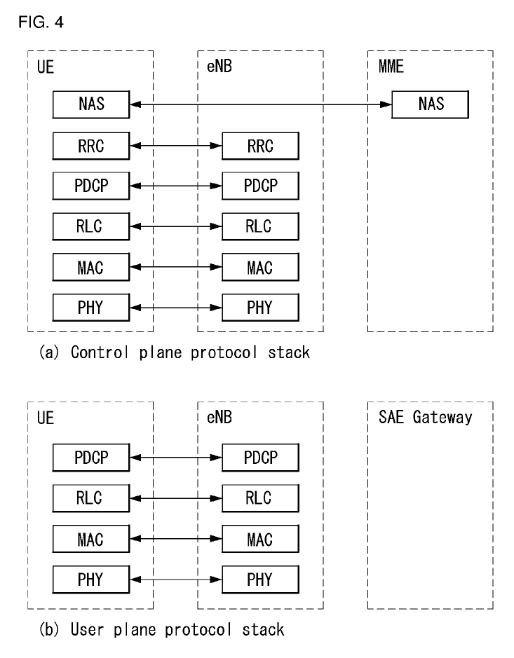

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

With reference to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, in case the MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and

Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.18, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

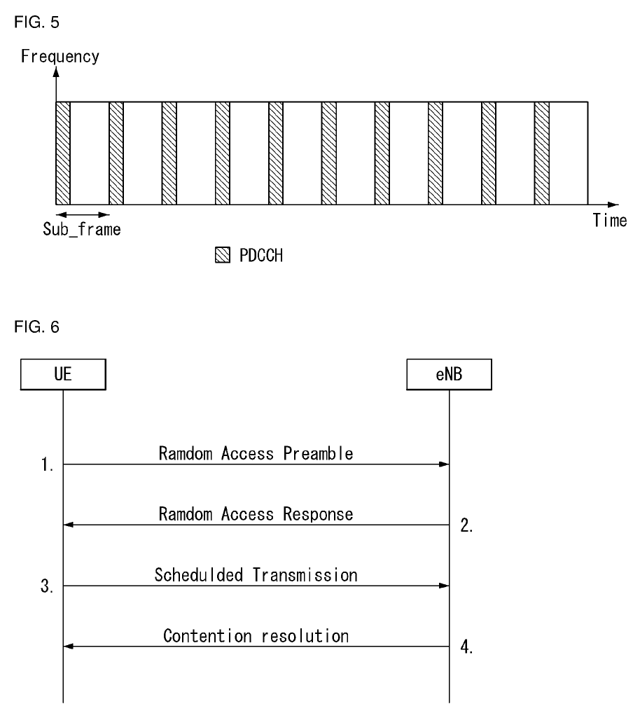

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol(s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (e.g., S-TMSI or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

X2-Based Handover

These procedures are used by a UE to perform handover from a source eNB to a target eNB using an X2 reference point. In this procedure, the MME is not changed. Two procedures are defined depending on whether the S-GW is not changed or relocated. In addition to the X2 reference point between the source eNB and the target eNeB, this procedure relies on the presence of an S1-MME reference point between the MME and the source eNB and between the MME and the target eNB.

Handover preparation and execution steps are performed as specified in TS 36.300. If an emergency bearer service for the UE is ongoing, handover to the target eNB is performed independently of a handover restriction list. The MME determines whether the handover is for a restricted area as part of tracking area update in the execution step, and if so, the MME releases a non-emergency bearer.

If a serving PLMN is changed during X2-based handover, the source eNB indicates, to the target eNB (within the handover restriction list), a PLMN selected as the new serving PLMN.

When the UE receives a handover command, the UE removes an EPS bearer which has not received a corresponding EPS radio bearer in the target cell. As part of the handover execution, downlink and optionally uplink packets are transferred from the source eNB to the target eNB. When the UE reaches the target eNB, the downlink data transmitted from the source eNB may be delivered to the target eNB. Uplink data from the UE may be delivered to the PDN GW via (source) S-GW or selectively transferred from the source eNB to the target eNB. Only a handover completion step is affected by a potential change of the S-GW, and the handover preparation and execution steps are the same.

When the MME receives a rejection regarding a NAS procedure (e.g., dedicated bearer establishment/modification/release, location reporting control, NAS message transmission, etc.) together with an indication that the X2 handover is ongoing from the eNB, the MME may retry the same NAS procedure when the handover is regarded as having been completed or failed, except for the case of S-GW relocation. When a timer for the NAS procedure expires, an error is determined as a failure.

When the X2 handover includes the S-GW relocation and the MME receives a rejection of an NAS message transport regarding a downlink NAS transport or downlink generic NAS transport message together with an indication that X2 handover is ongoing from the eNB, the MME retransmits the corresponding message to the target eNB when the handover is completed, and when the handover is regarded as having failed, the serving MME retransmits it to the source eNB.

When the MME receives a rejection regarding a NAS message transmission for a circuit switched (CS) service notification or a UE context modification request message involving a CS fallback indicator together with an indication that the X2 handover is ongoing from the eNB, the MME retransmits a corresponding message to the target eNB when the handover is completed or to the source eNB when the handover is regarded as having failed.

If the MME detects that the S-GW needs to be relocated during the handover procedure, the MME rejects an EPS bearer request initiated by the PDN GW received after the handover procedure started, and includes an indication that the request has been temporarily rejected due to the ongoing handover. The rejection is transferred by the S-GW to the PDN GW together with an indication that the request has been temporarily rejected.

When a rejection of the procedure initiated by the EPS bearer(s) PDN GW is received together with an indication that the request was temporarily refused due to the ongoing handover procedure, the PDN GW starts a locally set guard timer. The PDN GW retries by a predetermined number of times when the guard timer expires, when the handover is completed, or when message reception fails.

1) X-2-Based Handover without S-GW Relocation

This procedure is used for the UE to perform handover from the source eNB to the target eNB using X2 when the MME is not changed and the MME determines that the S-GW is not changed. The presence of an IP (Internet Protocol) connection between the S-GW and the source eNB and between the S-GW and the target eNB is assumed.

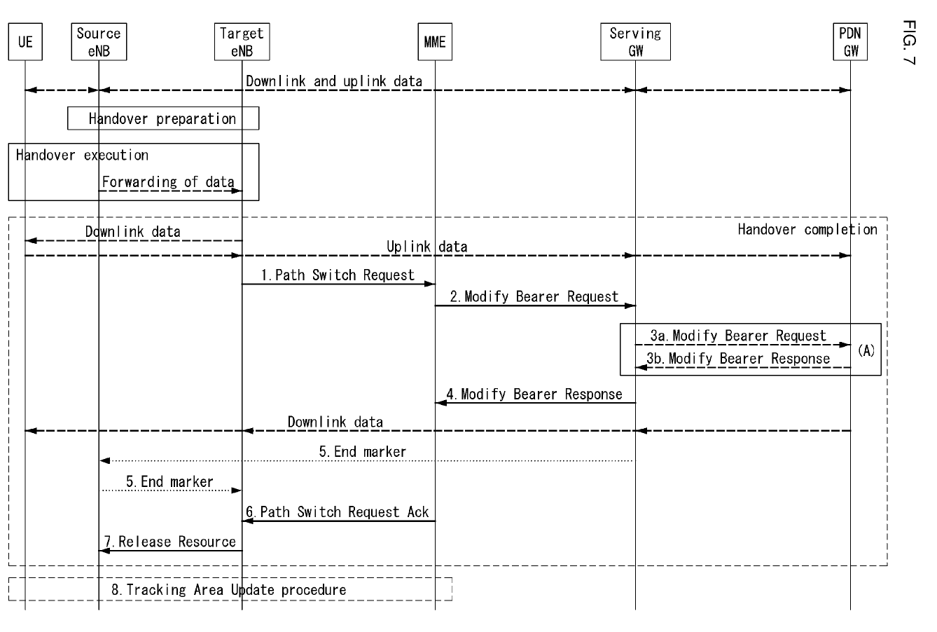

FIG. 7 illustrates an X2-based handover procedure without S-GW relocation in a wireless communication system to which the present invention may be applied.

1. In order to inform that the UE has changed a cell, the target eNeB transmits a path switch request message including a tracking area identity (TAI) of the target cell+E-UTRAN cell global identity (ECGI) and an EPS bearer list to be switched to the MME. When the target cell is a closed subscriber group (CSG) cell, the target eNB includes a CSG ID of the target cell in the path switch request message. When the target cell is in the hybrid mode, the target eNB includes a CSG IDD of the target cell and a CSG access mode set to “hybrid” in the path switch request message. Also, if the hybrid cell accessed by the UE has a CSG different from the source cell or if the source cell does not have a CSG ID, the path switch request message includes a CSG membership status information element (IE). If one of parameters is changed, the MME updates user CSG information based on the CSG ID received from the target eNB, the CSG access mode, and the CSG membership.

In the case of selected IP traffic offload (SIPTO) in a local network having a stand-alone GW structure, the target eNB includes a local home network ID of the target cell in the path switch request message.

The MME determines that the S-GW may continue to serve the UE.

2. Regarding each PDN connection that a basic bearer is accepted by the target eNB, the MME transmits, to the S-GW, a modify bearer request (eNB address(es) for a downlink user plane for an accepted EPS bearer), tunnel endpoint identifier (TEID), an idle state signaling reduction (ISR) activation message for each PDN connection. When the PDN GW requests location information change report, the MME includes user location information (IE) in the message, if it is different from previously sent information. If a UE time zone is changed, the MME includes the UE time zone IE in the message. If the serving network is changed, the MME includes a new serving network IE in the message. If ISR is activated before this procedure, the MME must maintain the ISR. The UE is informed of the ISR status in a tracking area update procedure. If the S-GW supports the modify access bearers request procedure and the S-GW does not need to send signaling to the P-GW, the MME may send a modify access bearer request (eNB address(es) for the downlink user plane and TEID, ISR activation) for each UE to the S-GW.

When the PDN GW requests the user CSG information of the UE (determined from the UE context), the MME includes the user CSG information IE in the message if the user CSG information is changed.

In order to determine whether a certain dedicated EPS bearer in the UE context has not been accepted by the target eNB, the MME uses the EPS bearer list to be switched received in step 1. The MME releases the unaccepted dedicated bearer by triggering the bearer release procedure. When the S-GW receives a downlink packet for the unaccepted bearer, the S-GW drops the downlink packet and does not transmit a downlink data notification to the MME.

If the basic bearer of PDN connection is not accepted by the target eNB and there are a plurality of activated PDN connections, the MME regards all bearers of the PDN connection as having failed and triggers an MME request PDN disconnection procedure to release the corresponding PDN connection.

If the target eNB has not accepted the basic EPS bearer or there is a local IP access (LIPA) PDN connection which has not been released, the MME performs the operation in step 6.

3. When the S-GW receives the user location information IE and/or the UE time zone IE and/or the serving network IE and/or the user CSG information IE from the MME in step 2, the S-GW sends, to associated PDN GW(s), a modify bearer request message (S-GW address and TEID, user location information IE and/or UE time zone IE and/or serving network IE and/or user CSG information IE) for each PDN connection, thus providing the information to the PDN GW(s) so that it may be used for charging, for example. The S-GW provides a modify bearer response message (S-GW address and TEID for uplink traffic) as a response to the modify bearer request message, or provides a modify access bearers response (S-GW address and TEID for uplink traffic) as a response to the modify access bearers request message.

When PMIP is used via an S5/S8 interface, if the S-GW cannot serve the MME request in the modify access bearers request message without S5/S8 signaling or without corresponding Gxc signaling, the S-GW responds to the MME that the modification is not limited to the S1-U bearer together with the indication and repeats the request using a modify bearer request message for each PDN connection.

4. The S-GW starts to transmit downlink packets to the target eNB using the newly received address and TEID. The modify bearer response message is sent to the MME.

5. To facilitate a reordering function in the target eNB, the S-GW sends one or more “end marker” packets in a previous path immediately after switching the path.

6. The MME checks a path switch request message with a path switch request ACK message. If an aggregate maximum bit rate (UE AMBR) is changed, for example, if all EPS bearers related to the same APN are rejected in the target eNB, the MME provides an updated value of the UE AMBR to the target eNB in the path switch request ACK message.

If a CSG membership status is included in the path switch request message, the MME includes a valid CSG membership status in the path switch request ACK message.

If some of EPS bearers are not successfully switched in a core network, which bearer for a dedicated bearer initiating a bearer release procedure has failed to be established is indicated in the path switch request ACK message in order to release core network resource of the failed dedicated EPS bearer. The target eNB deletes the corresponding bearer context when it is notified that the bearer has not been established in the core network.

If the primary EPS bearer has not been successfully switched in the core network or if it has not been accepted by the target eNB or if LIPA PDN connection is not released, the MME sends a path switch request failure message to the target eNB. The MME performs explicit detachment of the UE as described in a detach procedure initiated by the MME.

7. By sending a release resource, the target eNB informs the source eNB of the handover success and triggers release of the resource.

8. The UE initiates a tracking area update procedure when one of predefined conditions is applied. If the ISR is activated for the UE when the MME receives the tracking area update request, the MME maintains the ISR by marking ISR activation in the tracking area update accept message.

2) X2-Based Handover Procedure Involving S-GW Relocation

This procedure is used for the UE to perform handover from the source eNB to the target eNB using X2 when the MME is not changed and the MME determines that the S-GW is to be relocated. The presence of IP connection between the source S-GW and the source eNB, between the source S-GW and the target eNB, and between the target S-GW and the target eNB is assumed. Without IP connection between the target eNB and the source S-GW, S1-based handover procedure is used instead.

FIG. 8 illustrates an X2-based handover procedure involving S-GW relocation in a wireless communication system to which the present invention may be applied.

1. In order to inform that the UE has changed a cell, the target eNB sends a path switch request message including the ECGI of the target cell and the list of EPS bearers to be switched to the MME. If the target cell is a CSG cell, the target eNB includes the CSG ID of the target cell in the path switch request message. When the target cell is in the hybrid mode, the target eNB includes the CSG ID of the target cell and the CSG access mode set to “hybrid” in the path switch request. Also, if the hybrid cell accessed by the UE has a CSG different from the source cell or if the source cell does not have a CSG ID, the path switch request message includes a CSG membership status IE. The MME determines CSG membership based on the CSG ID received from the target eNB and the target PLMN id. When one of parameters is changed, the MME updates the user CSG information based on the CSG ID received from the target eNB, the CSG access mode, and the CSG membership.

In case of SIPTO in a local network having a stand-alone GW structure, the target eNB includes a local home network ID of a target cell in the path switch request message.

The MME determines that the S-GW has been relocated and selects a new S-GW according to the S-GW selection function.

2. Regarding each PDN connection for which a basic bearer was accepted by the target eNB, the MME sends, to the target S-GW, a create session request message for each PDN connection. Here, the create session request message includes TEID(s) in a PDN GW(s) for uplink traffic (in the case of GTP-based S5/S8), a bearer context(s) involving a GRE key (in the case of PMIP-based S5/S8), eNB address(es) for user plane downlink for accepted EPS bearers, a protocol type on S5/S8, a serving network, and a UE time zone. The target S-GW allocates an S-GW address and TEID(s) for uplink traffic on an S1-U reference point (one TEID per bearer). The protocol type on S5/S8 is provided to the S-GW and is used via the S5/S8 interface. When the PDN GW requests a location information change report, the MME includes a user location information IE in the message if it is different from previously sent information. When the PDN GW requests user CSG information of the UE (determined from the UE context), the MME includes the user CSG information IE in the message if the user CSG information is changed.

In order to determine whether a certain dedicated EPS bearer in the UE context has been received by the target eNB, the MME uses the list of EPS bearers to be switched received in step 1. The MME releases an unaccepted dedicated bearer by triggering the bearer release procedure via the target S-GW. When the S-GW receives a downlink packet for the unaccepted bearer, the S-GW drops the downlink packet and does not transmit a downlink data notification to the MME.

When the basic bearer of the PDN connection is not accepted by the target eNB and there are a plurality of active PDN connections, the MME regards all the bearers of the corresponding PDN connections as failed and releases the corresponding PDN connections by triggering a PDN connection disconnect procedure requested by the MME by way of the source S-GW.

If there is a LIPA PDN connection for which the basic EPS bearer has not been accepted or released by the target eNB, the MME performs the operation specified in step 5.

3. The target S-GW allocates an address and TEID (one per bearer) for the downlink traffic from the PDN GW. The S-GW also allocates the DL TEID on S5/S8 to the unaccepted bearer. The S-GW transmits, to the PDN GW(s), a modify bearer request (S-GW address(s) for the user plane and TEID(s), a serving network, a PDN charging pause support indication) message for each PDN connection. The S-GW also includes a user location information IE and/or a UE time zone IE and/or a user CSG information IE if it is present in step 2. The PDN GW updates its context field and transmits, to the S-GW, a modify bearer response (charging Id), mobile station international ISDN number (MSISDN), PDN charging pause enabled indication, etc.) message. The MSISDN is included when the PDN GW stores it in the UE context. The PDN GW starts to transmit a downlink packet to the target GW using a newly received address and TEID. These downlink packets will use the new downlink path to the target eNB via the target S-GW. The S-GW allocates the TEID for the failed bearer and informs the MME accordingly.

When the S-GW is relocated, the PDN GW sends one or more “end marker” packets on a previous path immediately after switching the path to assist the reordering function in the target eNB. The source S-GW forwards the “end marker” packet to the source eNB.

4. The target S-GW sends a create session response (S-GW address and uplink TEID for the user plane) message to the target MME. The MME starts a timer to use in step 7.

5. The MME checks the path switch request message by the path switch request ACK message (S-GW address and uplink TEID(s) for the user plane) message. If the UE-AMBR is changed, for example, if all EPS bearers associated with the same APN are rejected at the target eNB, the MME provides the target eNB with the updated value of the UE AMBR within the path switch request ACK message. The target eNB starts to use the new S-GW address and TEID to deliver a next uplink packet.

If the CSG membership status is included in the path switch request message, the MME includes a valid CSG membership status in the path switch request ACK message.

If some EPS bearers are not successfully switched in the core network, the MME indicates, in the path switch request ACK message, which bearer has failed to be established, and in the case of a dedicated bearer, the MME starts a bearer release procedure to release a core network resource of the failed dedicated EPS bearer. When informed that the bearer has not been established in the core network, the target eNB deletes the corresponding bearer context.

If the basic EPS bearer has not been successfully switched in the core network or has not been accepted by the target eNB or if the LIPA PDN connection has not been released, the MME sends a path switch request failure message to the target eNB. The MME performs explicit detachment of the UE in accordance with a detach procedure initiated by the MME.

6. By sending a release resource, the target eNB informs the source eNB of the handover success and triggers the release of the resource.

7. When the timer expires after step 4, the source MME releases the bearer in the source S-GW by sending a delete session request message (cause, operation instruction). If an operation indication flag is not set, the source MME instructs the source S-GW that the source S-GW should not start the deletion procedure for the PDN GW. The source S-GW responds with a delete session response message. If the ISR is activated prior to this procedure, the source MME sends a delete bearer request message to a precious CN node to instruct the source S-GW that the source S-GW should delete a bearer resource on a different previous CN node.

8. The UE initiates a tracking area update procedure when one of predefined conditions is applied.

Mobility Management in ECM-CONNECTED

Intra-E-UTRAN-access mobility support of ECM-CONNECTED for the UE handles all necessary procedures:
A handover procedure, a procedure of performing final handover (HO) determination on a source network side (control and evaluation of UE and eNB measurement in consideration of UE-specific roaming and access limitation), procedures preceding resource preparation of a target network side, a command for the UE to a new radio resource, and resource release on a finally (previous) source network side. This procedure includes transferring context data between evolved nodes and updating node relationships on C-plane and U-plane.
A dual connectivity (DC) specific procedure, procedures preceding final determination for a specific configuration (control and evaluation of measurement on the UE and network side) of secondary eNB (SeNB), each resource preparation on the SeNB network side, command for the UE to a new radio resource configuration for second connection, and release of resource of SeNB when applied. This procedure includes a mechanism of transferring UE and bearer context data between participating nodes and updating node relationships on C-plane and U-plane.

In the E-UTRAN RRC_CONNECTED state, network-controlled UE-assisted handover and DC-specific operation are performed and various DRX cycles are supported.

The UE measures the attributes of a serving cell and a neighbor cell to enable the following process:
It is not necessary to indicate neighbor cells for the UE to search for neighbor cells and measure a cell. That is, the E-UTRAN relies on the UE to search for neighbor cells;
In order to search and measure an inter-frequency neighboring, at least the carrier frequency should be indicated;
The E-UTRAN signals reporting criteria for event triggering and periodic reporting;
A neighbor cell list (NCL) is provided by the serving cell in RRC-dedicated signaling to handle a specific case for intra- and inter-frequency neighbor cells. The NCL includes cell-specific measurement parameters (e.g., cell specific offsets) for specific neighbor cells;
A blacklist may be provided to prevent the UE from measuring specific neighbor cells;

In the UE measuring discovery signal (i.e., CRS and/or CSI-RS) of serving and neighbor cells, the E-UTRAN indicates to the UE a measurement configuration including a measurement timing configuration of the discovery signals.

Measurements are classified as gap-assisted or non-gap assisted depending on whether the UE requires a transmit/receive gap to perform relevant measurement. The non-gap assisted measurement is measurement in a cell that does not require a transmit/receive gap to perform measurement. The gap-assisted measurement is measurement in a cell that requires a transmit/receive gap to perform measurement. A gap pattern (opposite to an individual gap) is configured and activated by RRC.

1) Handover

The intra E-UTRAN HO of the UE in the RRC_CONNECTED state is a UE-assisted network-controlled HO that accompanies HO preparation signaling in the E-UTRAN:
A portion of a HO command originates from the target eNB and is transported transparently to the UE by the source eNB;
To prepare HO, the source eNB forwards, to the target eNB, all necessary information (e.g., E-RAB (E-UTRAN Radio Access Bearer) attributes and RRC context):
When carrier aggregation (CA) is set and SCell selection is enabled in the target eNB, the source eNB may provide the best cell list and optionally the measurement result of a cell in decreasing order of radio quality.
When DC (Dual Connectivity) is set, the source MeNB (master eNB) adds secondary cell group (SCG) configuration to master cell group (MCG) and provides the same to the target MeNB.
Both the source eNB and the UE maintain some context (e.g., C-RNTI) to enable return of the UE in case of HO failure;
The UE accesses the target cell via a random access channel (RACH) following a contention-free procedure using a dedicated RACH preamble or a contention-based based procedure if the dedicated RACH preamble is not available:
The UE uses a dedicated preamble (successfully or unsuccessfully) until the handover procedure is completed.
If the RACH procedure toward the target cell is not successful within a certain time, the UE initiates a radio link failure recovery using an appropriate cell;
The ROHC (Robust Header Compression) context is not transmitted during handover;
ROHC context may be maintained during handover in the same eNB;

2) Handling of C-Plane (Control Plane)

The preparation and execution steps of the HO procedure are performed without EPC involvement. That is, a preparation message is exchanged directly between the eNBs. Release of resources on the source side during the HO completion step is triggered by the eNB. When a relay node (RN) is involved, the DeNB (Doner eNB) relays an appropriate S1 message between the RN and the MME (S1-based handover) and relays an X2 message between the RN and the target eNB (X2-based handover); The DeNB explicitly recognizes the UE connected to the RN due to an S1 proxy and X2 proxy function.

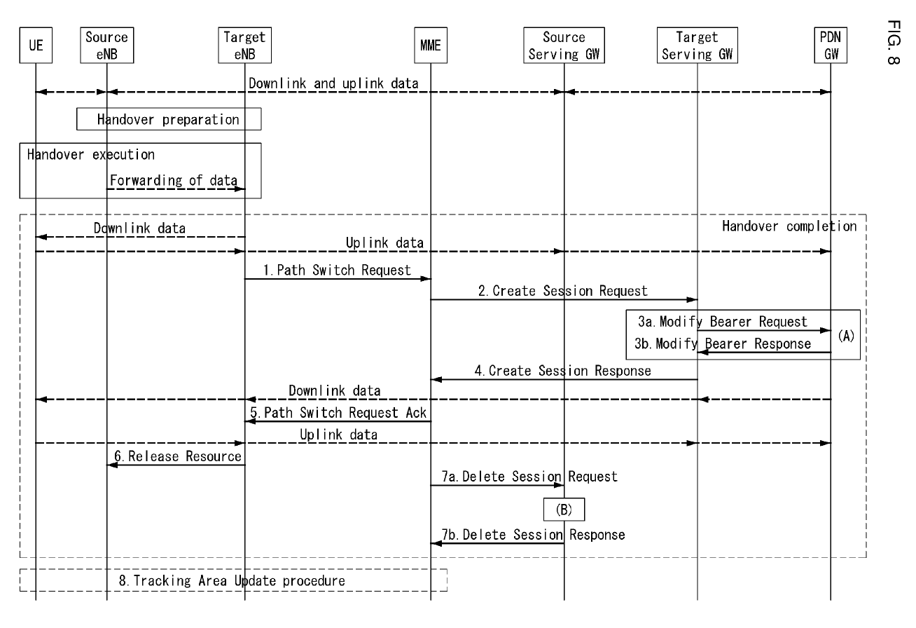

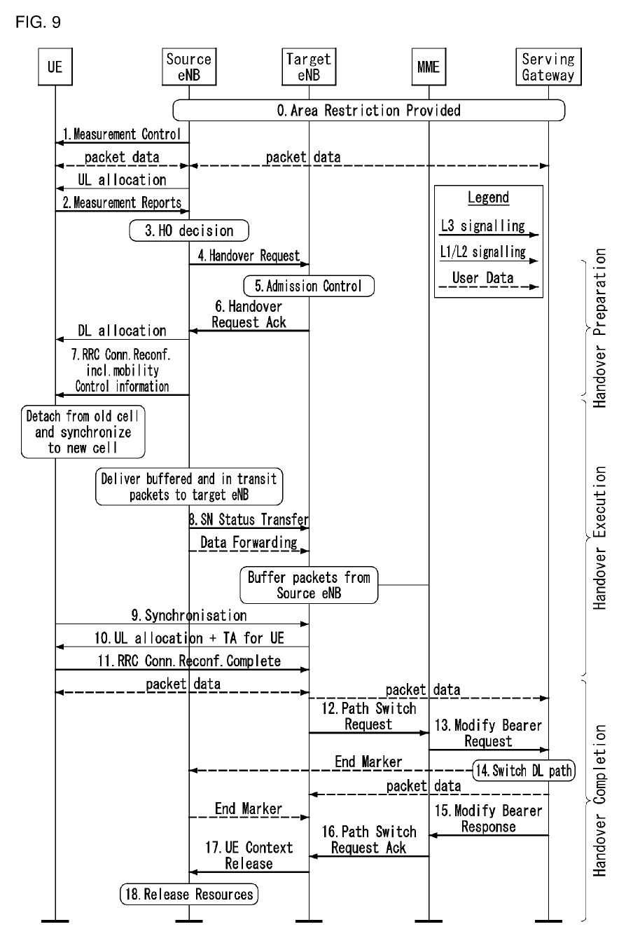

FIG. 9 illustrates a handover (i.e., intra-MME/S-GW HO) scenario in which the MME and the S-GW are not changed in a wireless communication system to which the present invention may be applied.

0. UE context within the source eNB includes information about roaming and access restrictions provided at the time of establishing connection or updating a final tracking area (TA).

1. The source eNB configures a UE measurement procedure according to the roaming and access restriction information (e.g., available multi-frequency band information). Measurement provided by the source eNB may support a function of controlling connection mobility of the UE.

2. The MEASUREMENT REPORT is triggered and sent to the eNB.

3. The source eNB determines to perform handover on the UE based on the MEASUREMENT REPORT and Radio Resource Management (RRM) information.

4. The source eNB sends a HANDOVER REQUEST message to the target eNB that transfers the information required for the target side to prepare HO (UE X2 signaling context reference at the source eNB, UE S1 EPC signaling context reference, target cell ID (identifier), KeNB*, RRC context including C-RNTI of UE at source eNB, AS configuration, E-RAB context of source cell and physical layer ID of source cell+short MAC-I (Message Authentication Code for data Integrity) for possible RLF recovery). The UE X2/UE S1 signaling reference allows the target eNB to address the source eNB and the EPC. The E-RAB context includes required radio network layer (RNL) and transport network layer (TNL) addressing information and a QoS profile of the E-RAB.

5. Admission control may be performed by the target eNB depending on the received E-RAB QoS information to increase a possibility of successful HO if resource may be approved by the target eNB. The target eNB configures necessary resources according to the received E-RAB QoS information, and reserves the C-RNTI and, optionally, the RACH preamble. The AS-configuration used in the target cell may be independently (i.e., “established”) or specified (i.e., “reconfigured”) as a delta, as compared to the AS-configuration used in the source cell.

6. The target eNB prepares HO with L1/L2 and transmits a handover request acknowledge to the source eNB. The handover request acknowledge message includes a transparent container to be transmitted to the UE as an RRC message to perform handover. The container may include a new C-RNTI, a target eNB security algorithm identifier for the selected security algorithm, a dedicated RACH preamble, and possibly other parameters (e.g., access parameters, SIB, etc.). The handover request acknowledge message may also include RNL/TNL information for a transfer tunnel if necessary.

Steps 7 to 16 provide a method for preventing data loss during HO.

7. The target eNB generates an RRC message for performing handover, i.e., an RRC connection reconfiguration message including mobility management information (mobilityControllnformation) to be transmitted to the UE by the source eNB. The source eNB performs required integrity protection and encryption of the message. The UE receives an RRCConnectionReconfiguration message including required parameters (i.e., a new C-RNTI, a target eNB security algorithm identifier, and optionally a dedicated RACH preamble, a target eNB SIB, etc.) and receives an instruction from the source eNB to perform HO. The UE does not need to delay handover execution to transfer an HARQ/ARQ response to the source eNB.

8. The source eNB transmits an SN STATUS TRANSFER message to the target eNB to transfer an uplink PDCP SN receiver status of the E-RAB to which PDCP status retention (i.e., RLC AM) is applied and downlink PDCP SN transmitter status. To the target eNB. The uplink PDCP SN receiver status may include a PDCP SN of at least a first missing UL service data unit (SDU) and include a bitmap of out-of-order reception status of UL SDUs that the UE needs to retransmit in the target cell. The downlink PDCP SN transmitter status indicates a next PDCP SN which the target eNB is to allocate to new SDUs without having a PDCP SN. The source eNB may omit transmission of this message unless any of the E-RABs of the UE is treated as PDCP state retention.

9. The UE receives an RRCConnectionReconfiguration message including mobilityControllnformation and subsequently performs synchronization with the target eNB, and if a dedicated RACH preamble in the mobilityControllnformation is indicated, the UE follows a contention-free procedure. If the dedicated RACH preamble is not designated, the UE access a target cell through the RACH according to the contention-based procedure. The UE derives a target eNB specific key and configures a selected security algorithm to be used in the target cell.

10. The target eNB responds with uplink allocation and timing advance.

11. If the UE successfully accesses the target cell, the UE transmits an RRC connection reconfiguration complete message (C-RNTI) to confirm handover for confirming handover to the target eNB in order to indicate that the handover procedure for the corresponding UE has been completed. Here, the UE also transmits an uplink buffer status report, if possible. The target eNB verifies the C-RNTI sent in the RRCConnectionReconfigurationComplete message. The target eNB may now start to transmit data to the UE.

12. The target eNB sends a path switch request message to the MME to inform that the UE has changed the cell.

13. The MME sends a MODIFY BEARER REQUEST message to the S-GW.

14. The S-GW switches the downlink data path to the target side. The S-GW may send one or more “end marker” packets to the source eNB on the previous path and release U-plane/TNL resources toward the source eNB.

15. The S-GW sends a MODIFY BEARER RESPONSE message to the MME.

16. The MME confirms the PATH SWITCH REQUEST message by a PATH SWITCH REQUEST ACKNOWLEDGE message.

17. By sending a UE CONTEXT RELEASE message, the target eNB informs the source eNB of the success of HO and triggers release of the resource by the source eNB. The target eNB sends this message after a PATH SWITCH REQUEST ACKNOWLEDG is received from the MME.

18. Upon receiving the UE CONTEXT RELEASE, the source eNB may release the radio and C-plane related resources associated with the UE context. The ongoing data transmission may continue.

When X2 handover including a HeNB (Home eNB) is used and a source HeNB is connected to a HeNB GW, a UE CONTEXT RELEASE REQUEST message including an explicit GW context release indication is issued to indicate that all resources related to the UE context may be released by the HeNB is transmitted by the source HeNB.

3) Handling of User Plane (U-Plane)

U-plane handling during intra-E-UTRAN-access operation for the UE which is ECM-CONNECTED considers the following principle to avoid data loss during HO:
During HO preparation, a U-plane tunnel may be established between the source eNB and the target eNB. There are one tunnel established for uplink data forwarding and another tunnel for downlink data transmission for each E-RAB to which data transmission is applied. In the case of the UE under RN performing handover, a transmission tunnel may be established between the RN and the target eNB via DeNB.
During HO execution, user data may be transferred from the source eNB to the target eNB. Transfer is service and disposition dependent and may be performed according to an implementation method.

The transfer of downlink user data from the source eNB to the target eNB is performed in order if a packet is received by the source eNB from the EPC or if a source eNB buffer is not empty.
Upon completion of HO:

In order to inform that the UE has acquired access and the MME transmits a MODIFY BEARER REQUEST message to the S-GW, the target eNB sends a PATH SWITCH message to the MME, and the U-plane path is switched from the source eNB to the target eNB by the S-GW.

The source eNB continues to transfer U-plane data as long as a packet is received by the source eNB from the S-GW or as long as the source eNB buffer is not empty.

In the case of RLC-Acknowledged Mode (RLC-AM) bearer:
In the case of general HO not including full configuration:

For sequential delivery and duplication prevention, the PDCP SN (sequence number) is maintained on a bearer basis, and the source eNB informs the target eNB of a next DL PDCP SN to be allocated to a packet that does not yet have a PDCP sequence number (from the source eNB or S-GW).

For security synchronization, a hyper frame number (HFN) is also maintained and the source eNB provides one reference HFN for UL and one reference HFN for DL to the target eNB (i.e., the HFN and corresponding SN).

In both the UE and the target eNB, a window-based mechanism is required for duplication detection.

The occurrence of duplication via an air interface at the target eNB is minimized by a PDCP SN based report at the target eNB by the UE. In uplink, a report is selectively configured on a bearer basis by the eNB, and the UE first transmits these reports when there are resources allocated in the target eNB. In downlink, the eNB determines about which bearer the report is to be transmitted and when the report is to be transmitted, and the UE does not wait for the report to resume uplink transmission.

The target eNB retransmits all downlink PDCP SDU(s) transferred by the source eNB, except for the PDCP SDU(s) acknowledged via the PDCP SN based on the report by the UE and prioritizes the PDCP SDU(s), (i.e., the target eNB must send data having the PDCP SN(s) before transmitting data from S1).
In the case of HO including full configuration:

The following description for an RLC-UM (RLC-Unacknowledged Mode) bearer is applied to the RLC-AM bearer. Data loss may occur.

In the case of RLC-UM bearer:

PDCP SN and HFN are reset in the target eNB.

PDCP SDU(s) are not retransmitted in the target eNB.

The target eNB prioritizes all downlink PDCP SDU(s) transferred by the source eNB (i.e., the target eNB must transmit data having PDCP SN(s) from X2 before transmitting data from S1).

A UE PDCP entity does not attempt retransmission for any PDCP SDU in the target cell completed in transmission in the source cell. Instead, the UE PDCP entity starts retransmission of the other PDCP SDU(s).

Session Management

Session management is responsible for setup of an IP or non-IP traffic connection for the UE as well as user plane management for the connection.

Hereinafter, packet data unit (PDU) session registration information and function related to session management will be described as a solution to session management.

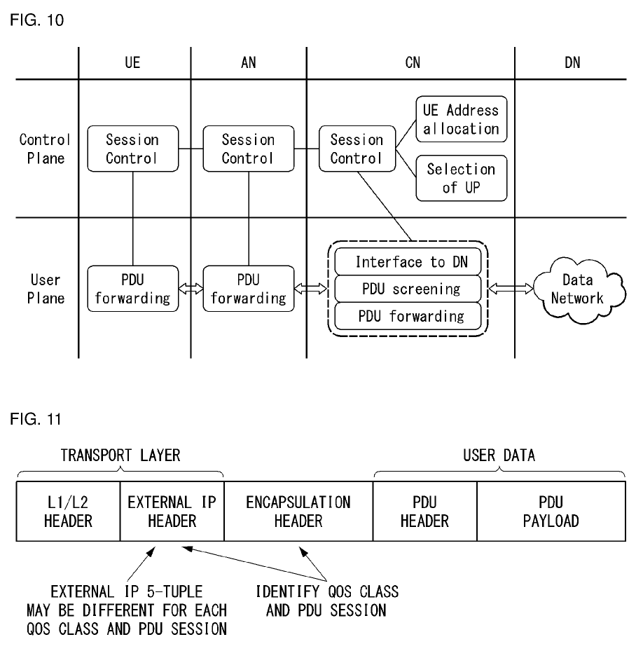

FIG. 10 is a diagram illustrating a session management function in a wireless communication system to which the present invention is applied.

A PDU connectivity service is provided by a PDU session.

The PDU session has the following characteristics:
A next generation (NextGen) system supports connectivity toward other types of data networks (e.g., Internet, IMS, enterprise/individual) and a DN is required to be distinguished by any type of identifier. The DN is identified by a DN name.
Each PDU session is associated with a PDU session type indicating which PDU type(s) are to be delivered by the PDU session. The PDU session type may be an IP (Internet Protocol) type, an Ethernet, or a non-IP type.

The following functions are included as part of the solution for session management:
Packet forwarding;
Packet screening, i.e., capability to check whether the UE uses a precise IP address/prefix assigned to the UE;
Overall functionality for handling session control, i.e., session management (SM) signaling and PDU session management;
User plane (UP) function is selected.

Session management functionality is used to provide a PDN connectivity service for different PDU types including IP, Ethernet, and non-IP types. Specific session management functionality is specific to the PDU type. For example, an IP address allocation for an IP-based PDU type. However, to implement a generic and reusable NextGen system, it is desirable that most of the functions are common to all other PDU types. The following assumption is applied to the solution:
A session management procedure (e.g., to establish a new PDU session and to modify/terminate an established PDU session) is common to all PDU types. However, part of information transferred by session management scheduling may be specific to a PDU (e.g., an IP address in the case of an IP-based PDU type)
The solution does not require PDU specific user plane transport between an access network (AN) and a core network (CN).

In the case of an IP-based data network, the following functions are also part of the solution for session management:
UE IP address assignment.

In the case of the IP-based data network, a PDU session may be identified by one or more assigned IP address(s)/prefix(s) and DN identifiers.

FIG. 10 illustrates assignment of a session management function to the UE, the AN, and the CN. In FIG. 10, no specific grouping of these functions is assumed in a logical network function/network entity. This may be assumed to be handled as part of an operation on an overall architecture.

UP (User Plane) Protocol Model

In 3GPP SA2, PDU session/QoS (quality of service) class/node level tunneling method and SDN (software defined networking)-based access method have been proposed as an UP protocol model of the next generation session management.

1) Tunnel Protocol for Each QoS Class

This solution addresses the UP protocol model.

Hereinafter, QoS parameters will be described.

A bearer (e.g., an EPS bearer) may include a QoS class identifier (QCI) and an allocation and/or retention priority (ARP) as basic QoS parameters.

QCI is a scalar used as a criterion for accessing node-specific parameters that control bearer level packet forwarding treatment. The scalar value is pre-configured by a network operator. For example, the scalar may be preset to any one of the integer values 1 to 9.

A main purpose of ARP is to determine whether a bearer establishment or modification request is to be accepted or rejected if resources are limited. In addition, the ARP may be used to determine which bearer(s) are to be dropped by the eNB in an exceptional resource restricted situation (e.g., handover, etc.).

The EPS bearer is classified as a guaranteed bit rate (GBR) bearer and a non-guaranteed bit rate (non-GBR) bearer according to QCI resource types. A default bearer may always be the non-GBR type bearer, and a dedicated bearer may be the GBR type or non-GBR type bearer.

The GBR type bearer has a GBR and a maximum bit rate (MBR) as a QoS parameters in addition to QCI and ARP. The MBR refers to allocation of a fixed resource (guaranteed bandwidth) for each bearer. Meanwhile, the non-GBR type bearer has an aggregated MBR as a QoS parameter in addition to the QCI and the ARP. The AMBR refers to that a maximum bandwidth which may be used with other non-GBR type bearers is allocated, rather than that resource is allocated for each bearer.

If the QoS of the EPS bearer is determined as described above, the QoS of each bearer is determined for each interface. The bearer of each interface provides QoS of the EPS bearer for each interface, and thus, all the EPS bearer, RB, S1 bearer, and the like, have a one-to-one relationship.

FIG. 11 illustrates a tunnel protocol for each QoS class in a wireless communication system to which the present invention may be applied.

In this option, one tunnel is present for each QoS class and PDU session between a pair of network functions (e.g., between up functions in a RAN node and the CN or between two UP functions in the CN). This option is similar to an operation in the EPC which has a separate outer Internet protocol (IP) header and separate encapsulation (i.e., GPT-U ((GPRS Tunnelling Protocol-User plane)) header.

This solution has the following additional characteristics:
The receiving cenpoint may use an external IP header in combination with an encapsulation header field to determine a PDU session and QoS class of a packet.
A new tunnel parameter needs to be established for each QoS class.
Signaling of tunneling information for each QoS class while on the move (although multiple QoS tunnels may be handled in the same message)
Support for duplicate UE IP version 4 (IPv4) addresses
Support for different PDU types (IP, Ethernet, non-IP)
End-user payload “layer” decoupled from a transport layer, allowing different techniques in the transport layer

2) Tunnel Protocol for Each PDU Session

This solution addresses the UP protocol model.

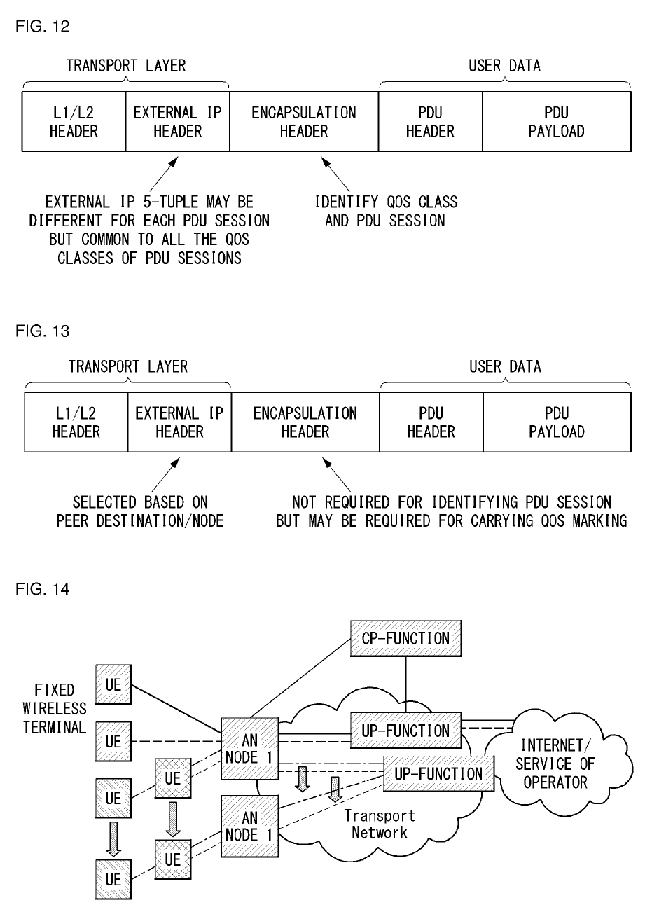

FIG. 12 illustrates a tunnel protocol for each node-level in a wireless communication system to which the present invention may be applied.

In this option, there is one tunnel for each PDU session between NF pairs (e.g., between UP functions in the RAN node and the CN or between two UP functions in the CN). All the QoS classes in the session share the same external IP header, but the encapsulation header may carry QoS marking.

This solution has the following additional features:

In order to determine which session the tunneled PDU belongs to, the receiving cenpoint uses an identifier in an encapsulation header, and may use the identifier in combination with the external IP header.
Common signaling for all QoS classes while on the move
Support for duplicate UE IPv4 addresses
Support for different PDU types (IP, Ethernet, non-IP)

End-user payload “layer” decoupled from the transport layer, allowing different technologies in the transport layer.

3) Tunnel Protocol for Each Node-Level

This solution addresses the UP protocol model.

FIG. 13 illustrates a tunneling protocol for each node-level for generating one tunnel for each destination in a wireless communication system to which the present invention may be applied.

In this option, there is a common tunnel for all traffic between NF pairs (e.g., between the UP functions in the RAN node and the CN or between the two UP functions in the CN).

This solution has the following additional features:
An identifier of the PDU session is not present in the external IP header or the encapsulation header. Instead, the endpoint needs to use information (e.g., the UE IP address in the case of an IP type PDU (PDU type IP)) in the end-user PDU to identify a session.
When an access network (AN) is connected to one UP accessing multiple data networks (DN), a tunnel is present for each node and DN between the AN and the UP function.
In the case of the IP type PDU (PDU type IP), PDU session traffic is identified based on the UE IP address. This requires the UE IP address to be unique within one DN to allow for clear traffic identification.
In the case of an Ethernet type PDU (PDU type Ethernet), a unique identifier for identifying a session in the UP function and the RAN node are required, and this is generated for each PDU type. This identifier is located in a PDU header as the UE IP address in the IP type PDU (PDU type IP)
An encapsulation header may or may not be needed (e.g., to carry an identifier for QoS purpose).
If the node/function supports multiple IP addresses, for example, a tunnel endpoint address may be required to be signaled to transfer traffic to the correct IP address of the node/function due to load balancing.
End-user payload “layer” decoupled from the transport layer, allowing different technologies within the transport layer.

In the case of one AN node, multiple tunnels connected to different user plane gateways (GWs) may be present. The node-level tunnel is applied to a fixed UE. Therefore, an operator may guarantee allocation of an IP address which is not duplicated in one DN to UE(s) belonging to the same node-level tunnel through setting.

FIG. 14 illustrates a scenario for a fixed wireless terminal and a mobile terminal in a wireless communication system to which the present invention may be applied.

This scenario, which is an access service for a fixed wireless terminal (e.g., loT (Internet or Things) UE or “last one mile”, may be applied when a CPE (Customer-Premises Equipment) UE) providing a fixed network comparable bandwidth is connected to a network. The fixed wireless terminal may require little movement or may not be allowed to move (e.g., for each subscriber).

The fixed UE scenario has numerous connections (e.g., loT cases) and a large amount of UP traffic (e.g., CPE cases). To simplify a tunnel, aggregated node-level tunnels may be used between next-generation access nodes and UP functions.

When the UE is attached to the network or sets up a PDU session to one DN, the CP-AU authorizes the UE type (e.g., fixed wireless UE type) and identifies whether an AN node level tunnel is applied. If so, the CP determines a corresponding tunnel for the PDU session based on information such as a DN name, tunnel termination information (e.g., UP IP address) or the AN node identifier provided by the AN.

UEs using the same AN node-level tunnel are connected to the same CP SM. The AN node identifies the UE's traffic through tunnel information (e.g., an external IP header) and the IP address of the UE.

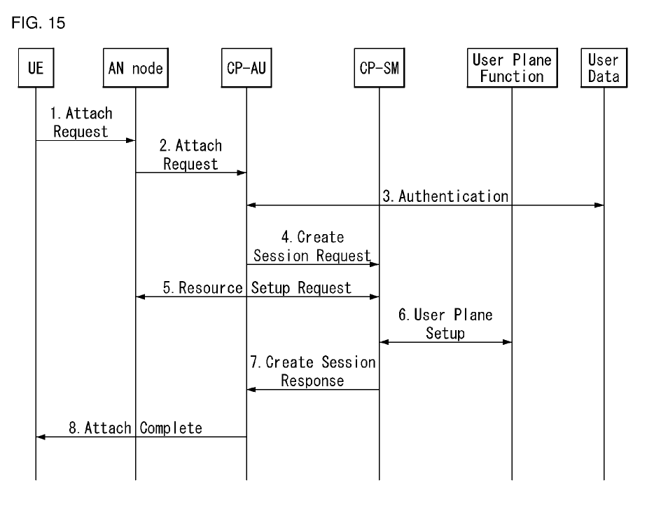

FIG. 15 illustrates an attachment of a UE to a network by an AN node-level tunnel in a wireless communication system to which the present invention may be applied.

In FIG. 15, “user data” (e.g., HSS, subscriber repository function, etc.) is data repository of session management and user subscription for authorization and information related to a user identifier. It may be a standalone network function or may be collocated with some network functions.

“CP-AU” is a function (or network entity) in the core network that performs an interaction with the user data (or subscriber repository function) to obtain an authentication procedure and authentication data of the UE.

“CP-SM” is a function (or network entity) in the core network that is responsible for establishing, maintaining and terminating an on-demand PDU session for UEs in the NextGen system architecture.

1. The UE transmits an attach request to the AN node. The UE type is included in the signaling (similar to the RRC message) associated with the Attach Request.

2. The AN node recognizes a UE type and transmits the same including node-level tunnel selection assisting information (i.e., tunnel end IP address and AN node identifier) together with Attach Request to the CP-AU.

3. The CP-AU verifies the PDU type and user subscription data such as the UE type to authenticate the UE.

4. The CP-AU sends a create session request message to the CP-SM.

5. The CP-SM selects the UP function based on information such as the DN name and the tunnel selection assisting information provided by the AN. The CP-SM assigns the UE IP address corresponding to the UP function. The CP-SM requests the AN to set up resources for the session.

6. The CP-SM function sets the user plane with the UP function. That is, it notifies the assigned UE IP address and indicates a traffic handling policy for a tunnel and a session used for the AN.

7. The CP-SM transmits a create session response to the CP-AU. This message includes the UE IP address.

8. The CP-AU sends an Attach complete to the UE.

Tunneling Model Management Method for UE Mobility

As described above, respective features and utilization cases regarding the UP protocol model are under discussion.

For example, a tunneling model (i.e., tunnel protocol) for each node-level may be applied to services in which fixed wireless terminals such as loT are used. Here, the loT UE may be a special UE which rarely moves or is not allowed for movement. Such a tunneling model for each node-level may be readily used when a large number of non-mobile UEs wants be served by the same DN (Data Network).

As described above, three UP protocol models have been proposed as the next generation protocol models. Although each model has a different utilization case and required parameters, it is expected that all tunneling models will be available now in the NextGen system but it is not yet confirmed.

That is, the access network (AN) may or may not support all three tunneling models. Thus, the following problems may arise.

In coverage of an access node (e.g., a base station, an eNB, etc.) supporting a tunneling model A, when the UE which is provided with a specific service (i.e., a specific DN or APN (APN refers to a PDN identifier and refers to a character string for designating or identifying the PDN) moves to another AN (for the reason of handover, etc.), the source AN must select a target AN.

Here, with the current technology, the source access node cannot know which tunneling model the target access node supports.

In this situation, if the target access node selected by the source access node does not support the tunneling model A, the UE cannot be provided with the current tunneling service, and therefore, the UE may need to newly establish another tunneling.

Further, the aforementioned situation may occur even when the UE (connected to two or more different DNs) which uses two or more types of tunneling models (e.g., tunneling for each node-level and tunneling for each session-level) should select another AN.

In order to solve the problem, the present invention proposes a method by which the source access node may select a target access node optimal for the UE.

In particular, the present invention proposes a method whereby when a UE mobility event (e.g., handover) occurs in which the source access node must select a target access node, the UE transmits information required for the source access node to select a target access node, to the source access node (e.g., through measurement reports, etc.).

In the present invention, it is assumed that capability for a tunneling model supported by each access node is different (e.g., an access node in a specific area supports only the tunneling model A and does not support other tunneling models).

Also, in the description of the present invention, the tunneling model refers to at least one of the tunneling model for each QoS class, the tunneling model for each session, and the tunneling model for each node-level.

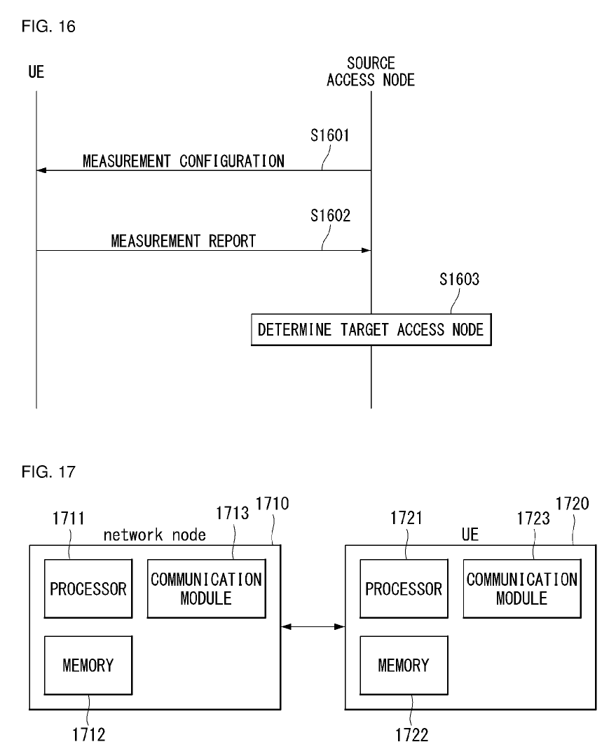

FIG. 16 is a diagram illustrating a method for supporting mobility of a UE according to an embodiment of the present invention. Referring to FIG.

Referring to FIG. 16, the source access node (e.g., a source base station, etc.) transmits a measurement configuration to the UE (S1601).

Here, the measurement configuration may be transmitted when the UE starts to be served by the source access node (e.g., when the UE performs an attach process through the source access node or establishes a session using a specific tunnel).

Here, the measurement configuration may instruct to include information on capability of a neighbor access node for a tunneling model (e.g., ‘tunneling model which can be supported by the neighbor access node’ and/or ‘tunnel currently supported by the neighbor access node’ and/or ‘list of neighbor access nodes for supporting a tunneling model in use by the UE) in the UE's measurement report. That is, the measurement configuration may include capability information for the tunneling model of the neighbor access node as information to be included in the measurement report by the UE.

The information that the UE should include in the measurement report may be as follows.

1) For example, the source access node may instruct to include information regarding which tunneling model can be supported by each access node adjacent to the UE (i.e., a neighbor access node) in the measurement report to report the same. That is, the measurement configuration may include a tunneling model that may be supported by the access node (i.e., neighbor access node) near the UE as information to be included in the measurement report by the UE.

Here, each access node may (periodically) provide (e.g., broadcast) a list of tunneling models which can be supported by each access node through a system information block (SIB).

For example, the information on a tunneling model that the access node may support may be informed to the UE in the form shown in Table 2 below.

Table 2 illustrates information about a tunneling model that an access node may support, according to one embodiment of the present invention.

TABLE 2

| Tunneling model which can be supported by access node | Value |
|---|---|
| Support tunneling model for each QoS level (class) | 001 |
| Support tunneling model for each session level | 010 |
| Support tunneling model for each node-level | 100 |

Referring to Table 2, for example, when an access node is able to support a tunneling model for each QoS level (class) and a tunneling model for each node-level, 101, as a value for the information on the tunneling model supported by the access node, may be included in the SIB and transmitted to the UE.

Based on this, the UE may acquire information required by the source access node (i.e., information on the tunneling model that the neighbor access node may support).

Here, the source access node may request only for a specific tunnel model or may request all information about a supportable tunneling model.

For example, the source access node may instruct to include information regarding whether the neighbor access node can support the tunneling model for each QoS level (class) in the measurement report and transmit the same. Here, if each neighbor access node can support tunneling for each QoS level (class), the UE may include 1 in the measurement report and transmit the same to the source access node, and if each neighbor access node cannot support tunneling, the UE may include 0 in the measurement report and transmit the same to the source access node.

2) In another example, the source access node may instruct to include information regarding which tunnel each access node near the UE currently supports in the measurement report and report the same. That is, the measurement configuration may include tunnels (and DNs) currently supported by access nodes (i.e., neighbor access nodes) near the UE as information to be included in the measurement report by the UE.

Here, the UE may obtain information (i.e., tunneling model and DN) for the tunnel that the access node currently has (i.e., established) via the SIB from the adjacent access node (i.e., neighbor access node).

For example, information on a tunnel currently supported by the access node may be reported to the UE in the form shown in Table 3 below.

Table 3 illustrates information about tunnels currently supported by the access node according to an embodiment of the present invention.

TABLE 3

| DN name | Tunnel model | value |
|---|---|---|
| DN1 | Tunnel for each QoS level (class) | 001 |
| DN2 | Tunnel for each session level | 010 |

Referring to Table 3, it is shown that the access node is connected to DN1 through a tunnel according to the current QoS level (class), and is also connected to DN2 through a tunnel for each session level.

3) In another example, the source access node may instruct the UE to include the list of neighbor access nodes for supporting the tunneling model in use and report the same. That is, the measurement configuration may include a list of neighbor access nodes for supporting a tunneling model being used by the UE as information to be included in the measurement report by the UE.

Here, as described above, the UE may acquire information on the tunneling model that may be supported through the SIB from the neighbor access node. Then, the UE may select neighbor access nodes capable of supporting (or incapable of supporting) the tunneling model that the UE is currently using. The list of selected neighbor access nodes may then be included in the measurement report and transmitted to the source access node.

Here, the UE may only transfer the above information to the source access node only when it is explicitly informed to forward the above information(s) from the source access node.

Here, whether the UE is to transfer the light of neighbor access nodes for supporting a tunneling model (see Table 2) which can be supported by a neighbor access node, a tunnel (see Table 3) currently supported by the neighbor access node, or a tunneling model that the UE is in use to the source access node or whether to transfer two or more pieces of information to the source access node or to all source access nodes may be explicitly determined by the source access node.

Here, the measurement configuration may be interpreted as having the same meaning as measurement control in FIG. 9 above.

The source access node may provide a measurement configuration applicable to the UE (e.g., UE which is in RRC_CONNECTED) using a dedicated signaling (e.g., an RRC connection reconfiguration) message or an RRC connection resume message.

The type of information that the UE reports to the source AN may be changed by the network operator policy or the subscription information of the UE.

The measurement configuration may include the following parameters:

1) Measurement objects: targets to be measured by the UE.

In the case of intra-frequency measurement (measurement at a downlink carrier frequency of serving cell(s)) and inter-frequency measurement (measurement at a frequency different from downlink frequency(s) of the serving cell(s), the measurement object may correspond to a single carrier frequency. In connection with this carrier frequency, the access node may set up a cell specific offset list, a ‘blacklisted’ cell list, and a ‘whitelisted’ cell list. The blacklisted cells are not considered in event evaluation or measurement reporting.

In the case of inter-RAT measurements (measurements at frequencies such as UTRA/GERAN/CDMA2000/WLAN), the UTRA/GERAN/CDMA2000/WLAN carrier frequency (or set) may correspond.

2) Reporting configurations: List of reporting configurations. Each report configurations may include the following:
Criterion: A criterion that triggers the UE to send a measurement report. This criterion may be applied to periodic reporting or single event reporting.
Report Format: Quantity to be included in the measurement report by the UE (e.g., reference signals received power (RSRP), reference signals received quality (RSRQ), received signaling strength indicator (RSSI), etc, may be included) and the related information (e.g., the number of cells to report)

Here, the report format may include capability information for the tunneling model of the neighbor access node so that the UE may include it in the measurement report and transmit the same.

Here, the capability information for the tunneling model of the neighbor access node may include ‘the tunneling model which can be supported by the neighbor access node’ and/or ‘the tunnel currently supported by the neighbor access node’ described above.

In this case, the UE may include the tunneling model which can be supported by each neighbor access node and/or currently supported tunnel information in the measurement report and transmit the same to the source access node.

In addition, the report format may include a list of neighbor access nodes for supporting the tunneling model being used by the corresponding UE so that the UE may include the list in the measurement report and transmit the same. In this case, the UE may receive the tunneling model that may be supported and/or currently supported tunnel information from each neighbor access node via the SIB, select neighbor access nodes capable of supporting (or incapable of supporting) the tunneling model that the corresponding UE is using. Then, the UE may include the list of the selected neighbor access nodes (i.e., a list of neighbor access nodes for supporting the tunneling model in use by the corresponding UE) in the measurement report and transmit the same to the source access node.

Here, the list of neighbor access nodes for supporting the tunneling model used by the corresponding UE may include only the neighbor access node capable of supporting the tunneling model that the UE is using.

Alternatively, the list of neighbor access nodes for supporting the tunneling model used by the corresponding UE may include both a neighbor access node capable of supporting the tunneling model being used by the UE and a neighbor access node which cannot support the tunneling model being used by the UE, and here, whether each neighbor access node can support may be indicated together.

Alternatively, the list of neighbor access nodes for supporting the tunneling model that the UE is using may include both the neighbor access node capable of supporting the tunneling model being used by the UE and the neighbor access node which cannot support the tunneling model being used by the UE, and the neighbor access node capable of supporting the tunneling model being used by the UE may be prioritized.

3) Measurement identities(s): A list of measurement identifier(s). Here, one report configuration may be applied to each measurement identity and each measurement identity may be linked to one measurement target. By setting a plurality of measurement identities, one or more measurement targets may be linked to the same report configuration and one or more report configurations may be linked to the same measurement target. The measurement identity is used as a reference number in a measurement report.

4) Quantity configurations: One quantity configuration may be set for each RAT type. The quantity configuration may define an associated filtering used for related report of a measurement quantity and all event evaluation and a measurement type. One filter may be set for each measurement quantity.

5) Measurement gaps: Cycle (i.e., (uplink, downlink) transmission is not scheduled) that the UE may use to perform measurement.

The access node may set one measurement object for a given frequency. That is, two or more measurement objects for the same frequency to which different associated parameters (e.g., different offsets and/or black lists, etc.) are applied cannot be configured. The access node may set multiple instances of the same event (e.g., by setting two report configurations having different thresholds).

The UE may maintain one measurement target list, one report configuration list, and one measurement identify(s) list. The measurement target list may include measurement target(s) specified for each RAT type (Also, it may include intra-frequency target(s) (e.g., target(s) corresponding serving frequency(s), inter-frequency target(s), inter-RAT target(s)). A measurement target may be linked to a report configuration of the same RAT type. Some report configurations may not be linked to the measurement target. Similarly, some measurement targets may not be linked to the report configuration.

If the measurement report is triggered, the UE sends a measurement report to the source access node (S1602).

Here, the UE may include, in the measurement report, capability information for the tunneling model of the neighbor access node indicated by the source access node (e.g., ‘tunneling model that can be supported by neighbor access node’ and/or ‘tunnel currently supported by neighbor access node’ and/or ‘list of neighbor access nodes for supporting tunneling model used by the UE’) and transmit the same to the source access node.

Here, the measurement report may be transferred through one of the following methods or using both methods.

Periodic Measurement Report: The UE may include capability information for the tunneling model of the neighbor access node in a periodic measurement report and transfers the same to the source access node.

Measurement report when specific event occurs: The UE may send a measurement report to the source access node when signal strength of the source access node (e.g., RSRP, RSRQ, RSSI, etc.) is smaller than a predetermined threshold value, and here, the UE may include capability information for the tunneling model of the neighbor access node in the measurement report.

Alternatively, when signal strength (e.g., RSRP, RSRQ, RSSI, etc.) of the neighbor source access node is higher than signal strength of the source access node although signal strength (e.g., RSRP, RSRQ, RSSI, etc.) of the source access node is not lower than a predetermined threshold value, the UE may transmit the measurement report to the source access node, and here, the UE may include capability information for the tunneling model of the neighbor access node in the measurement report.

The source access node determines a target access node for the UE to perform handover based on the measurement report (S1603).

That is, the source access node may perform one of the following operations based on the measurement report (i.e., including the capability information for the tunneling model of the neighbor access node). received from the UE. Here, the determination on the following operations may be based on the number of sessions that the UE currently has (i.e. established) and the type of tunnel.

1) When the UE has Only a Session Using a Specific Tunneling Model A

The source access node may select, as a target access node, an access node having highest signal strength, among the access nodes which can support the UE, based on the measurement report received from the UE and the capability information for the tunneling model of the neighbor access node included in the measurement report.

That is, the source access node may select, as the target access node, the access node having highest signal strength, among the access node which is able to support the tunneling model A and/or the access node which is able to support a tunnel of the tunneling model A.

Here, the source access node may determine a target access node based on other information (e.g., load status information of the neighbor access node, etc.) received through a control plane from a node of the core network, as well as the signal strength.

2) When the UE has a session using a tunneling model other than the session using the tunneling model A (e.g., the UE is connected to the DN 1 through a tunnel of a tunneling model for each node-level and also connected to DN 2 through a tunnel of a tunneling model for each session level)

The source access node may select a target access node as follows based on the measurement report received from the UE and the capability information on the tunneling model of the neighbor access node included therein.

a) The source access node may determine, as a target access node, an access node, which has highest signal strength, while supporting all the tunnel models that the UE is currently using, among the access nodes included in the capability information for the tunneling model of the neighbor access node transmitted by the UE.

b) When an access node which support all the tunneling models currently used for the UE is not present in the capability information for the tunneling model of the neighbor access node received from the UE and only an access node which support only some tunneling models is present (e.g., when the UE requires tunneling modes A and B but only an access node supporting tunneling models A and C or tunneling models B and C is present)

In this case, the source access node may preferentially select an access node supporting a tunneling model having a higher priority among the tunneling models currently used by the UE. That is, the neighbor access node having the highest signal strength among the neighbor access nodes supporting the tunneling model having the high priority may be determined as the target access node.

Here, the source access node may know the priority of the tunneling model by receiving priority of the tunneling model from the node of the core network through the control plane, or the priority may be previously set in the source access node.

Meanwhile, information on the tunneling model that may be supported by the neighbor access node may be previously configured in the source access node.

In this case, in step S1601, the source access node may not instruct to include capability information on the tunneling model of the neighbor access node in the measurement report of the UE, in the measurement configuration. Also, in step S1602, the UE may not include capability information on the tunneling model of the neighbor access node in the measurement report.

In this manner, when information on the tunneling model which can be supported by the neighbor access node is previously configured, the source access node may determine the target access node in consideration of the measurement report of the UE and the tunneling model currently used by the UE.

1) When the UE has Only a Session Using the Tunneling Model A

The source access node may determine, as the target access node, the access node which supports the tunneling model currently being used by the UE and has the highest signal strength, among the target access node candidates (i.e., among the neighbor access nodes whose signal strength is equal to or higher than a certain threshold).

2) When the UE has a session using a tunneling model other than the session using the tunneling model A (e.g., the UE is connected to DN 1 through a tunnel of the tunneling model for each node level and connected to DN 2 through a tunnel of a tunneling model for each session level)

In this case, the source access node performs the following operations.

a) The source access node may determine, as a target access node, an access node which supports all the tunneling models currently used by the UE and which has the highest signal strength, among the target access node candidates (i.e., among neighbor access nodes whose signal strength is equal to or higher than the certain threshold)

b) When a neighbor access node candidate which supports all the tunneling models being used by the UE is not present and only a neighbor access node candidate which supports only some tunneling models is present (e.g., the current UE requires tunneling models A and B but only an access node supporting tunneling models A and C or tunneling models B and C is present)

In this case, the source access node may preferentially select an access node supporting a tunneling model having a higher priority among the tunneling models currently used by the UE. That is, the neighbor access node having the highest signal strength among the neighbor access nodes supporting the tunneling model having the high priority may be determined as the target access node.

Here, the source access node may know the priority of the tunneling model by receiving priority of the tunneling model from the node of the core network through the control plane, or the priority may be previously set in the source access node.

As described above, the source access node determines handover of the UE, and as a process after the UE determines the target access node to which the UE is to perform handover, the process after step 4 in FIG. 9 described above may be performed in the same manner.

Generic Devices to which the Present Invention May be Applied

FIG. 17 is a block diagram of a communication device according to an embodiment of the present invention.

Referring to FIG. 17, a wireless communication system includes a network node 1710 and a plurality of terminals (UEs) 1720.

The network node 1710 includes a processor 1711, a memory 1712, and a communication module 1713. The processor 1711 implements the functions, processes, and/or methods proposed in FIGS. 1 to 16 described above. Layers of wired/wireless interface protocol may be implemented by the processor 1711. The memory 1712 is connected to the processor 1711 and stores various types of information for driving the processor 1711. The communication module 1713 is connected to the processor 1711 to transmit and/or receive a wired/wireless signal. For example, an access node, a base station, a CP-AU, a CP-SM, a UP function, user data, an MME, an HSS, an SGW, and a PGW may correspond to the network node 1710. In particular, when the network node 1710 is a base station, the communication module 1713 may include a radio frequency (RF) unit for transmitting/receiving wireless signals.

The terminal 1720 includes a processor 1721, a memory 1722, and a communication module (or RF unit) 1723. The processor 1721 implements the functions, processes and/or methods proposed FIGS. 1 to 16 described above. Layers of an air interface protocol may be implemented by the processor 1721. The memory 1722 is coupled to the processor 1721 and stores various types of information for driving the processor 1721. The communication module 1723 is coupled to the processor 1721 to transmit and/or receive wireless signals.

The memory 1712 or 1722 may be present within or outside the processor 1711 or 1721 and may be connected to the processor 1711 or 1721 by various well known means. Also, the network node 1710 (in the case of a base station) and/or the terminal 1720 may have a single antenna or multiple antennas.

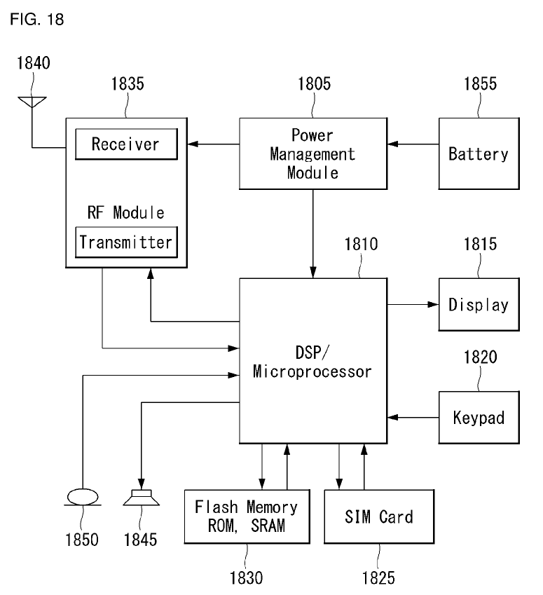

FIG. 18 is a block diagram of a communication device according to an embodiment of the present invention.

In particular, FIG. 18 illustrates the terminal of FIG. 17 in more detail.

Referring to FIG. 18, a UE may include a processor (or a digital signal processor (DSP) 1810, an RF module (or RF unit) 1835, a power management module 1805, an antenna 1840, a battery 1855, a display 1815, a keypad 1820, a memory 1830, a subscriber identification module (SIM) card 1825 (this component is optional), a speaker 1845 and a microphone 1850. The terminal may include a single antenna or multiple antennas.

The processor 1810 implements the functions, processes, and/or methods proposed in FIGS. 1 to 16 described above. Layers of an air interface protocol may be implemented by the processor 1810.

The memory 1830 is connected to the processor 1810 and stores information related to an operation of the processor 1810. The memory 1830 may be present without or outside the processor 1810 and may be connected to the processor 1810 by various well known means.

A user enters instructional information, such as a telephone number, for example. by pushing the buttons of a keypad 1820 or by voice activation using the microphone 1850. The microprocessor 1810 receives and processes the instructional information to perform the appropriate function, such as to dial the telephone number. Operational data may be retrieved from the SIM card 1825 or the memory module 1830 to perform the function. Furthermore, the processor 1810 may display the instructional and operational information on the display 1818 for the user's reference and convenience.

The RF module 1835 is connected to the processor 1810, transmits and/or receives an RF signal. The processor 1810 issues instructional information to the RE module 1835, to initiate communication, for example, transmits radio signals comprising voice communication data. The RE module 1835 comprises a receiver and a transmitter to receive and transmit radio signals. An antenna 1840 facilitates the transmission and reception of radio signals. Upon receiving radio signals, the RF module 1835 may forward and convert the signals to baseband frequency for processing by the processor 1810. The processed signals would be transformed into audible or readable information outputted via the speaker 1845.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

An embodiment of the present invention may be implemented by various means, for example, hardware, firmware, software or a combination of them. In the case of implementations by hardware, an embodiment of the present invention may be implemented using one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers and/or microprocessors

In the case of implementations by firmware or software, an embodiment of the present invention may be implemented in the form of a module, procedure, or function for performing the aforementioned functions or operations. Software code may be stored in the memory and driven by the processor. The memory may be placed inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The present invention is applied to a 3GPP LTE/LTE-A system is primarily described, but may be applied to various wireless communication systems in addition to the 3GPP LTE/LTE-A system.

What is claimed is:

1. A method for supporting mobility of a user equipment (UE) by a source access node in a wireless communication system, the method comprising:
transmitting, to the UE, a measurement configuration instructing to include capability information regarding tunneling models of neighbor access nodes in a measurement report;
receiving, from the UE, the measurement report including capability information regarding the tunneling models of the neighbor access nodes; and
determining a target access node to which the UE is to perform handover on the basis of the measurement report.

2. The method of claim 1, wherein
the capability information regarding tunneling models of neighbor access nodes includes a list of neighbor access nodes for supporting a tunneling model which may be supported by each of the neighbor access nodes, a tunnel currently supported by each of the neighbor access nodes and/or a tunneling model in use by the UE.

3. The method of claim 2, wherein
the list of neighbor access nodes for supporting the tunneling model in use by the UE
includes only a neighbor access node which may support the tunneling model in use by the UE,
includes both the neighbor access node which may support the tunneling model in use by the UE and a neighbor access node which cannot support the tunneling model in use by the UE, wherein whether each of the neighbor access nodes may support the tunneling model is indicated, or
includes both the neighbor access node which may support the tunneling model in use by the UE and the neighbor access node which cannot support the tunneling model in use by the UE, wherein the neighbor access node which may support the tunneling model in use by the UE is given a high priority.

4. The method of claim 1, wherein
information regarding the tunneling model which may be supported by the neighbor access node and/or information regarding the tunnel currently supported by the neighbor access node are broadcast in a system information block from the neighbor access nodes, respectively.

5. The method of claim 1, wherein
an access node having highest signal strength, among access nodes which may support the tunneling model of the UE, is determined as the target access node on the basis of the capability information regarding the tunneling models of the neighbor access nodes.

6. The method of claim 1, wherein
when a plurality of sessions using different tunneling models for the UE are established, an access node having highest signal strength, among access nodes which may support all of the tunneling models for the UE, is determined as the target access node on the basis of the capability information regarding the tunneling models of the neighbor access nodes.

7. The method of claim 1, wherein
when a plurality of sessions using different tunneling models for the UE are established, an access node having highest signal strength, among access nodes which may support tunneling models with high priority among the tunneling models for the UE, is determined as the target access node on the basis of the capability information regarding the tunneling models of the neighbor access nodes.

8. The method of claim 7, wherein
information regarding the priority is received from a node of a core network or the priority is previously set in the source access node.

9. The method of claim 1, wherein
the tunneling models include a tunneling model for each QoS class, a tunneling model for each packet data unit (PDU) session, and/or a tunneling model for each node level.

10. A source access node for supporting mobility of a user equipment (UE) in a wireless communication system, the source access node comprising:
a communication module transmitting and receiving signals; and
a processor controlling the communication module,
wherein the processor
transmits, to the UE, a measurement configuration instructing to include capability information regarding tunneling models of neighbor access nodes in a measurement report;
receives, from the UE, the measurement report including capability information regarding the tunneling models of the neighbor access nodes; and
determines a target access node to which the UE is to perform handover on the basis of the measurement report.
